(19) United States
(12) Patent Application Publication
(10) Pub. No.: US 2007/0268413 A1
(43) Pub. Date: Nov. 22, 2007

(54) System and method for sharing video input jacks

(76) Inventor: Dale Wayne King, Noblesville, IN (US)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(21) Appl. No.: 11/881,965

(22) Filed: Jul. 29, 2007

(30) Foreign Application Priority Data
Feb. 3, 2005 (US) PCT/US05/03300

(51) Int. Cl. H04N 5/268

(52) U.S. Cl. 348/706

(57) ABSTRACT

The disclosed embodiments relate to a system and method for decoding video signals. A video unit (10) may comprise a detection circuit (16) coupled to a luminance input jack (36), a red color difference input jack (38), and a blue color difference input jack (40), the detection circuit (18) adapted to detect a sync signal portion of a video signal received by the video unit (10); and a video processor (14) coupled to the detection circuit (16), the video processor (14) adapted to decode the video signal as a component video signal if the detection circuit (16) detects that the sync signal portion is being received through the luminance input jack (36). The method may comprise the acts of configuring the video unit (10) to detect a sync signal portion of a video signal received by the video unit (10) and configuring the video unit (10) to decode the video signal as a component video signal if the sync signal portion is detected as being received through a luminance input jack (36).

### FIELD OF THE INVENTION

The present invention relates generally to decoding video signals on a video unit. More specifically, the present invention relates to a system for sharing video input jacks, and a method for manufacturing a video unit that can accept multiple input video types on a single set of input jacks.

### BACKGROUND OF THE INVENTION

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Modern video units, such as cathrode ray tube (“CRT”) televisions, LCD (“Liquid Crystal Display”) monitors or televisions, plasma screen televisions, audio/video receivers, or video projectors, need to provide a variety of input jacks in order to facilitate the growing number of video output devices, such as video cassette recorders (“VCR”) digital video disc (“DVD”) players, computers, or satellite television receivers. There are a variety of video input signal types, both analog and digital.

Typically, the video unit will also have an audio input that corresponds to each of the video input types. This audio input may comprise one RCA jack for the left channel and one RCA jack for the right channel. In alternate embodiments, there may be other types of audio inputs.

With the growth over the past few years of the consumer video market, the number of video inputs on modern video units has grown tremendously. For example, a video unit may need five separate video inputs in order to accommodate a user that wishes to connect a VCR, a DVD player, a video camera, a satellite receiver, and a computer to a single video unit. Because each of these video sources may use either composite or component video, the video unit may have both a composite video jack and three component video jacks for each input. Each set of composite and component video jacks may also have two or more audio jacks that accompany it-resulting in a total of six jacks per video input. At six jacks per input, the video unit example described above with five inputs would have a total of thirty jacks. These thirty jacks may occupy a significant amount of space on the video unit. Reducing the number of jacks is desirable.

### SUMMARY OF THE INVENTION

The disclosed embodiments relate to a system and method for decoding video signals. A video unit may comprise a detection circuit coupled to a luminance input jack, a red color difference input jack, and a blue color difference input jack, the detection circuit adapted to detect a sync signal portion of a video signal received by the video unit; and a video processor coupled to the detection circuit, the video processor adapted to decode the video signal as a component video signal if the detection circuit detects that the sync signal portion is being received through the luminance input jack. The method may comprise the acts of configuring the video unit to detect a sync signal portion of a video signal received by the video unit and configuring the video unit to decode the video signal as a component video signal if the sync signal portion is detected as being received through a luminance input jack.

### BRIEF DESCRIPTION OF THE DRAWINGS

In the drawings:

FIG. 1 is a block diagram of a video unit with shared video input jacks in accordance with embodiments of the present invention; and

FIG. 2 is a diagram of shared video input jacks in accordance with embodiments of the present invention.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Composite video and component video are two analog video input signal types. Composite video is a video type that is used in most present consumer video equipment, such as the televisions and VCRs discussed above as well as camcorders, digital cameras, and a variety of other video recording and display devices. Typically, composite video is transmitted over a wire with RCA-style plugs on either side. These RCA plugs can be inserted into RCA-style jacks in both the video unit that will display the video as well as the video output device. In alternate embodiments, the RCA-style plug may be integrated into the video output device. In this case, the transmission wire and the output device may be a single unit.

Composite video combines the color portion, luminance portion, and synchronization portion (hereafter referred to as the “sync” portion) of a video image into a single, combined video signal. Typically, composite video is comprised of four hundred and eighty visible lines in an interlaced format. When video is displayed in an interlaced format, a display may show the odd lines during one scan of the display, and then show the even lines during the next scan of the display. The complete video image may be created on the display by repeating this process thirty times per second. This type of video input signal may be referred to as 480i because, as described above, it has four hundred and eighty visible lines and is interlaced.

Composite video may also be referred to as 1H because composite video is the base line for rating the horizontal sync frequency of a video signal. Horizontal sync frequency is the number of times per second that an electron beam within the display can trace a pattern horizontally across the display from one side to the other and then back.

Turning now to component video, which is a newer video input type that separates brightness and color into separate signals. Specifically, component video consists of a luminance signal, referred to as “Y,” a blue color difference signal referred to as “Pb,” and red color difference signal, referred to as “Pr.” Typically, the sync portion of a video signal is transmitted along with the luminance signal in component video. Breaking the video signal into three parts produces higher quality video at the display. Similar to composite video, each of the component video signals are typically transmitted over RCA-style cables. This means that both the video unit and the video output device will typically have RCA jacks.

Unlike composite video, component video may support a wide variety of video signal formats. First, component video may support 480i or 1H. In this case, the component video signal may be no higher resolution than a composite video signal. Component video may also support 480p, which is also referred to as 2H. As with 480i video signals, a 480p video signal comprise a video signal that has 480 lines of video. However, unlike 480i, the 480p video signal is not interlaced. Rather, all of the 480 displayable lines may be displayed at once. Showing all of the displayable lines at once is known as progressive scanning, and 480p gets its name from the fact that it has four hundred and eighty displayable lines that are progressively scanned. 480p is also known as 2H because the horizontal sync frequency of 480p is twice that of 480i.

Component video is also capable of transmitting a 1080i video signal. 1080i video signals consist of one thousand and eighty displayable lines of video in an interlaced scan. 1080i video signals are also referred as 2.14H because the horizontal sync frequency of the 1080i video signal is approximately 2.14 times that of 480i.

Lastly, component video is capable of transmitting 720p video signals. 720p video signals comprise seven hundred twenty displayable lines of video in a progressive scan. 720p video signals are also referred to as 3H because the horizontal sync frequency of the 720p video signal is approximately three times that of 480i video signal. Those skilled in the art will appreciate that in alternate embodiments, component video is also capable of displaying video signals at a variety of other horizontal sync frequencies and with a variety of other numbers of displayable lines, such as 1080p.

As discussed above, it may be desirable to reduce the number of video input jacks on a video unit. One way to accomplish this is to use shared video input jacks. This can be done because both composite video and component video may be transmitted over wires that have RCA-style plugs and may be inserted into RCA-style jacks on the video unit. As such, the number of video input jacks can be reduced if one of the component video input jacks is also used as the input jack for composite video signal. In one embodiment, the composite video signal may be transmitted to the video unit via the Pb input jack. In another embodiment, the composite video may be transmitted via the Pr input jack. In either case, however, if the video unit is not be able to determine whether the incoming video signal is a composite video signal or a color difference portion (either the Pr or Pb) of a component video signal, the video unit may not be able to properly display the video signal.

One way to overcome this potential issue is for the user to manually select the video input type. This may be done through some type of user interface. However, many consumers, especially those inexperienced with video equipment, may either not understand the need to select an input video type or may not understand how to set the input video type. In this case, the input video signal may be displayed incorrectly. The input video display may also be displayed incorrectly if the user is unaware of the need to select a video input type and the default video input type either composite or component does not match the input signal type.

In one embodiment, the video input type may be automatically set by detecting which one of the shared video input jacks of the video unit is being used to receive the sync portion of a video signal. Recall from above that the video unit may receive an entire composite video signal, which includes the sync portion of the composite signal, through either the Pb input jack or the Pr input jack whereas the video unit may receive the sync portion of a component signal through the Y input jack. As described in more detail below, the video unit may be able to use this feature to automatically select the proper input video type.

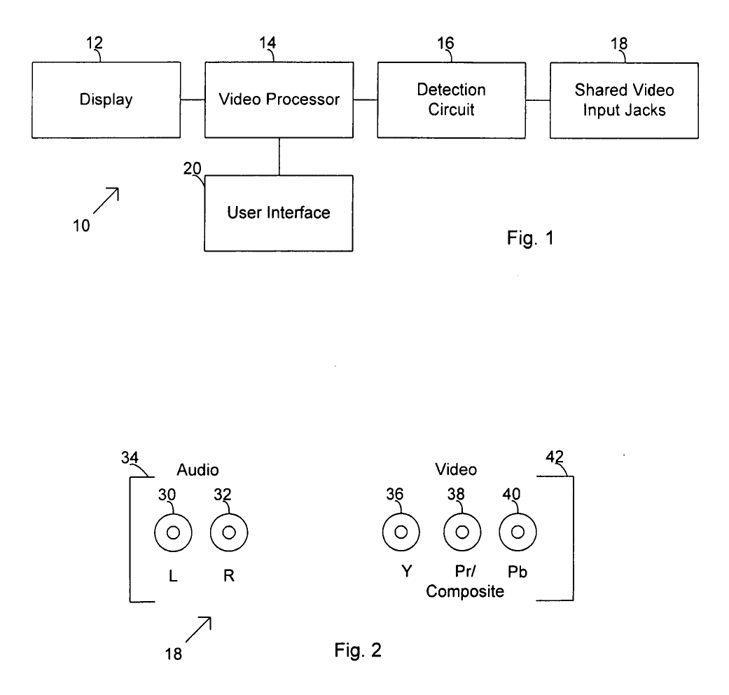

FIG. 1 is a block diagram of a video unit with shared video input jacks in which embodiments of the present invention may be employed. The diagram is generally designated by a reference numeral 10. The video unit 10 may comprise a display 12, a video processor 14, a detection circuit 16, shared video input jacks 18, and a user interface 20. The display 12 may include any type of video display. Examples include, but are not limited to CRT televisions, LCD screens, plasma screens, digital light processing (“DLP”) systems, or projectors. The display 12 may display the video input signal and may be used in conjunction with the user interface 20 to select a video input type.

The display 12 may be coupled to the video processor 14. The video processor 14 may convert a video signal into the form necessary to be displayed on the display unit 12. The video processor 14 may also contain logic or programming to permit the user to set-up the video unit 10. This set-up process may include selecting a video input type for a particular video input. The video processor 14 may also be coupled to the user interface 20. The user interface 20 may permit the user to interface the video processor 14 and to select the video input type for a particular video input.

The video processor 14 may also be coupled to the detection circuit 16. In one embodiment, the detection circuit 16 may comprise one or more sync detectors that may be coupled to the shared video input jacks 18. The detection circuit 16 may be configured to determine whether the input video is a composite video signal or a component video signal. In one embodiment, this determination may be made by detecting whether the video unit 10 is receiving the sync portion of the video signal through the luminance input jack (36 in FIG. 2). In this embodiment, if the sync portion is being received through the Y input jack, the detection circuit 16 may determine that the input video type is component video. If, on the other hand, the detection circuit 16 does not detect that the sync portion is being received through the Y input jack, the detection circuit 16 may determine that the input video type is composite video.

Once the detection circuit 16 determines the input video type, it may send a signal to the video processor 14 informing the video processor 14 of the input video type. When the video processor 14 receives this signal, it may set the video input type to match the input video type detected by the detection circuit 16.

Lastly, the detection circuit 16 may be coupled to the shared video input jacks 18. FIG. 2 is a diagram of the shared video input jacks in which embodiments of the present invention may be employed. The diagram is generally referenced by the reference numeral 18. The shared video input jacks 18 will typically be RCA-style input jacks. Those skilled in the art, however, will appreciate the techniques disclosed in the present application may be practiced with other types of input jacks. The shared video input jacks 18 may comprise a set of audio input jacks 34 and a set of video input jacks 42. The set of audio input jacks 34 may include a left channel audio jack 30 and a right channel audio jack 32. The left channel audio jack 30 may be connected to a wire carrying an audio signal for the left channel speakers whereas the right channel audio jack 32 may be connected to a wire carrying an audio signal for the right channel speakers. Those skilled in the art will appreciate that in alternate embodiments, the set of audio jacks 34 may be comprised of more than two audio jacks or may be absent entirely.

As described above, the shared video input jacks 18 may also comprise the set of video input jacks 42. The set of video input jacks 42 will typically consists of three video input jacks: the luminance input jack (also referred to as the “Y” input jack), a red color difference/composite input jack 38 (also referred to as the “Pr” input jack or the “Pr/Composite” input jack), and a blue color difference input jack 40 (also referred to as the “Pb” input jack). As described above, in alternate embodiments, the composite video input jack may also be the Pb input jack 40. In this embodiment, the Pb input jack 40 may be referred to as the “Pb/Composite” input jack 40. As with the set of audio jacks 34, the set of video input jacks 42 will typically be RCA-style input jacks. However, in alternate embodiments the set of video input jacks 42 may be a different style of input jack.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

1-20. (canceled)

21. A video unit comprising:
a detection circuit coupled to a luminance input jack and at least one of a red color difference input jack and a blue color difference input jack, the detection circuit adapted to detect a sync signal portion of a video signal received by the video unit; and
a video processor coupled to the detection circuit, the video processor adapted to decode the video signal as a composite video signal if the detection circuit detects that the sync signal portion is being received through the red color difference input jack or the blue color difference input jack.

22. The video unit set forth in claim 21, wherein video processor is adapted to decode the video signal as a composite video signal if the detection circuit does not detect that the sync signal portion is being received through the luminance input jack.

23. The video unit set forth in claim 21 comprising a set of audio input jacks.

24. The video unit set forth in claim 21, comprising a display unit configured to display the video signal.

25. The video unit set forth in claim 24, wherein the video unit comprises an LCD television.

26. The video unit set forth in claim 24, wherein the video unit comprises a plasma screen television.

27. The video unit set forth in claim 24, wherein the video unit comprises a video projector.

28. The video unit set forth in claim 24, wherein the video unit comprises an audio/video receiver.

29. A method comprising:
configuring a video unit to detect a sync signal portion of a video signal received by the video unit; and
configuring the video unit to decode the video signal as a composite video signal if the sync signal portion is detected as being received through a red color difference input jack or a blue color difference input jack.

30. The method set forth in claim 29, comprising configuring the video unit to decode the video signal as a composite video signal if the sync signal portion is not detected as being received through a luminance input jack.

31. The method set forth in claim 29 comprising the video unit to decode audio signal received through a set of audio input jacks.

32. The method set forth in claim 29, comprising configuring the video unit to display the video signal.

33. A video unit comprising:
means for detecting a sync signal portion of a video signal received by the video unit; and
means for decoding the video signal as a composite video signal if the sync signal portion is detected as being received through a red color difference input jack or a blue color difference input jack.

34. The video unit set forth in claim 33, wherein the means for decoding comprises a circuit that decodes the video signal as a composite video signal if the sync signal portion is not detected as being received through the luminance input jack.

35. The video unit set forth in claim 33, comprising a set of audio input jacks.

36. The video unit set forth in claim 33, comprising a display unit that is adapted to display the video signal.

37. The video unit set forth in claim 36, wherein the display unit comprises a plasma screen television.

38. The video unit set forth in claim 36, wherein the video unit comprises an LCD television.

39. The video unit set forth in claim 36, wherein the video unit comprises a video projector.

40. The video unit set forth in claim 36, wherein the video unit comprises an audio/video receiver.
